(19) United States
(12) Patent Application Publication
(10) Pub. No.: US 2009/0199456 A1
(43) Pub. Date: Aug. 13, 2009

(54) FISHING JIG CONSTRUCTION

(75) Inventor: Donald E. Lutyens, Naperville, IL (US)

Correspondence Address: BANNER & WITCOFF, LTD., TEN SOUTH WACKER DRIVE, SUITE 3000, CHICAGO, IL, 60606, US

(73) Assignee: Structure Proof Tackle Company, Inc., Naperville, IL (US)

(21) Appl. No.: 12/030,624

(22) Filed: Feb. 13, 2008

(51) Int. Cl. A01K 83/00

(52) U.S. Cl. 43/43.2; 43/43.16

(57) ABSTRACT

A jig construction for fishermen includes coplanar hook sections including a barb, a curved section, a first and a second straight section. The first and second straight sections are angle with respect to each other and a coplanar eyelet is also provided at the opposite end from the barbed end.

### BACKGROUND OF THE INVENTION

In a principal aspect the present invention relates to fishing jig constructions which may be used with a natural, live or an artificial bait or lure.

The structure of fishing hooks and tackle is an important consideration for the sport fisherman. Fishing equipment which will ensure a successful fishing venture is highly desired by sportsmen. Heretofore, there has been made available a fishing lure or jig which incorporates a barbed hook wherein the hook is bent at a midpoint or adjacent the midpoint so that various lure type elements may be incorporated with the hook. FIG. 1 is an example of such a jig.

Nonetheless, there has remained a need for an improved fishing jig or lure and, in particular, a jig or lure which is generally weedless. That is to say, a jig which can be utilized in conditions where aquatic weeds and the like are found and where fish are likely to habitat is very desirable. Such a jig or lure should be capable of avoiding entanglement in weeds, etc.

### SUMMARY OF THE INVENTION

Briefly, the present invention comprises a jig for fishing which includes a hook having a barbed end and an eyelet end. The hook is formed in a series of integral sections including a curved section extending from the barbed end defining a curve or smooth arcuate surface in the range of about 150° to about 190°. This first curved section is connected to a first straight run section. The first straight run section is coplanar with the curved section. The first straight section is joined to a second straight run section which is also coplanar with the curved section and first run section and forms an obtuse angle with the first straight run section in the range of about 120° to about 150°. The eyelet end is an extension of the second straight run section and again is coplanar with the curved section. A non-spherical, bulbous element is formed generally symmetrically around the second straight run section.

Typically, the bulbous section is a torpedo shape or curved symmetrical shape, but not spherical. It extends typically at least 50% of the length of the second straight run section. The maximum diameter of the bulbous element is typically less than one half of the longitudinal dimension of the bulbous element.

As an additional feature, a straight rod element extends from the second straight run section outwardly toward the barbed end and may extend over the barbed end. The rod element may be flexible to facilitate the weedless feature of the jig.

As a further feature of the invention, the jig may be used in combination with bait such as artificial bait or live bait.

As another feature of the invention, a weedless jig for fishing may include a hook with a barbed end having the configuration of the embodiment described above and further including an eyelet end which extends and is incorporated in a third straight run section extending normal to the second straight run section. The jig may also include a rod extension element (typically flexible) projecting toward and optionally over the barbed end.

Thus, it is an object of the invention to provide improved fishing jig constructions.

A further object of the invention is to provide improved fishing jigs which are weedless.

Yet another object of the invention is to provide jigs for fishing which may be used with artificial bait or live bait.

Another object of the invention is to provide fishing jigs which are not susceptible to snagging and which serve as a positive and efficient way to provide a successful fishing experience.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a plan view of a prior art fishing jig;

FIG. 2 is a plan view of a first embodiment of the invention;

FIG. 3 is a plan view of a second embodiment of the invention;

FIG. 4 is a plan view of a third embodiment of the invention;

FIG. 5 is a plan view of a fourth embodiment of the invention;

FIG. 6 is an isometric view of the use of an embodiment of the invention;

FIG. 7 is an isometric view of a further step in the use of the invention; and

FIG. 8 is an isometric view of a further step in the use of the invention.

### DESCRIPTION OF EMBODIMENTS OF THE INVENTION

FIG. 1 depicts a prior art jig construction. A hook 9 includes a barbed end 10 connected with a curved section 12, a first straight section 14, a second straight section 16, a third straight section 20 with an end eyelet 22. A spherical ball 24 is fitted symmetrically around the second section 16. An extension element 26 is formed at the juncture of the second section 16 and first section 14 and is joined to ball 24. The various sections and curved end are all coplanar. The ball 24 encapsulates the wire forming the jib and the bend thereof between second section 16 and third section 20.

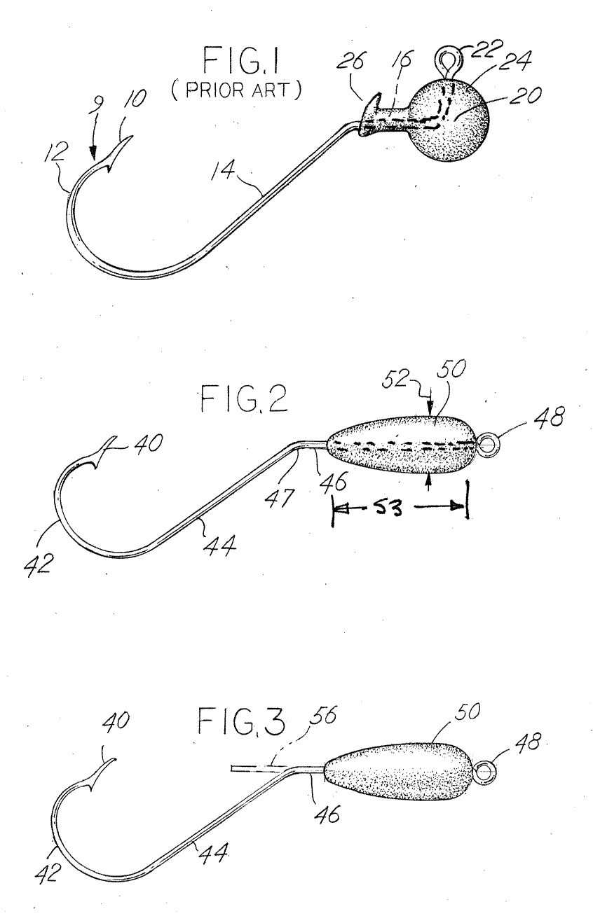

FIG. 2 illustrates an embodiment of the invention which includes a barbed end 40 connected with a curved or smooth arcuate section 42 that extends in the range of 150° to 190°. The curved section 42 is joined to a straight coplanar run section 44. A second straight run coplanar section 46 forms an angle in the range of 120° to 150° with the first coplanar run section 44. The second run section 46 terminates with an eyelet 48 which is a longitudinal extension of the second section 46 and which is coplanar with the various sections 42, 44 and 46.

A bulbous element 50 is formed symmetrically around the second section 46 and extends at least 50% of the length and preferably about 75% to 90% of the second section 46 from the eyelet 48 toward the junction 47 between first and second sections 44 and 46. The bulbous section 50 has a torpedo shape and is symmetrically positioned or formed around the second section 46. The bulbous section 50 has a maximum diameter 52 which is less than the longitudinal dimension 53 of the bulbous section 50, typically less than one half. Other bulbous type sections may be utilized, but it is noted that the bulbous section 50 is non-spherical in order to provide for improved passage of the embodiment through the water and to also enhance a weedless feature.

FIG. 3 depicts an alternative embodiment of the embodiment of FIG. 2. In the embodiment of FIG. 3 a rod element 56 extends from the junction 47 toward the barbed end 40. The rod element 56 may extend partially toward or over the barb of barbed end 40 and is coplanar with the other sections 40, 42, 46. Rod element 56 may be flexible.

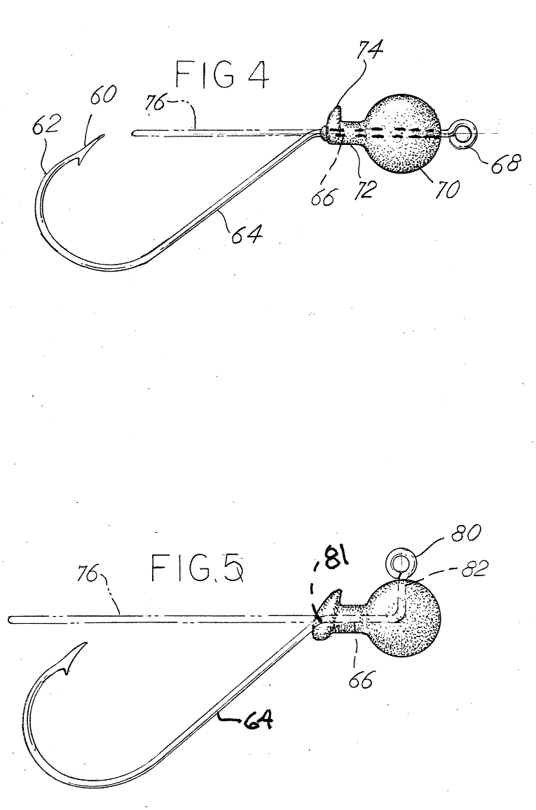

FIG. 4 illustrates an alternative embodiment. Referring to FIG. 4, the jig construction includes a barbed end 60, a curved section 62, a first straight run section 64 and a second integral, straight run section 66, all of which are coplanar. The second section 66 terminates with a coplanar eyelet 68. A spherical element 70 fits around the second section 66 adjacent the eyelet 68. The spherical element 70 includes a projecting symmetrical tubular section 72 with a prong 74 projecting upwardly therefrom coplanar with the other sections 60, 62, 64 and 66. The first and second sections 64 and 66 form an angle in the range of 120° to 150°. Importantly, the eyelet 68 is coplanar with the other sections 60, 62, 64 as described and is a straight extension thereof. As an alternative to the embodiment of FIG. 4, a rod element 76 (in phantom) may comprise an extension of the second section 66, again providing a weedless feature.

FIG. 5 depicts yet another embodiment of the invention. In FIG. 5 an eyelet 80 is associated with a third section 82 extending perpendicular to the second section 66. Further, an extension rod 76 extends from the junction 81 of the first and second sections 64 and 66 to enhance the weedless character of the jig. The embodiment of FIG. 5 is an improvement to the prior art embodiment of FIG. 1.

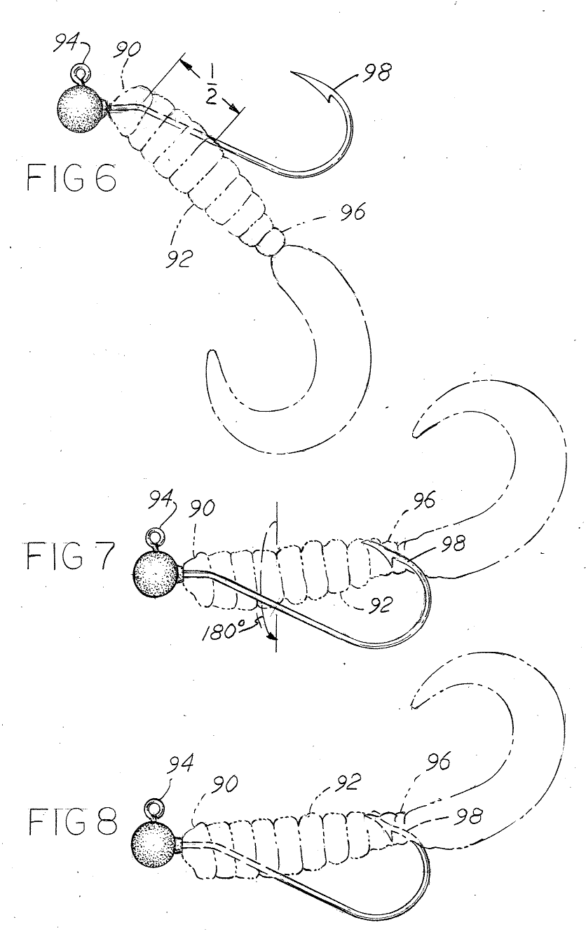

With the various embodiments, it is possible to provide attachment of artificial or live bait by fitting the bait through and onto the hook and the various elements such as depicted in FIGS. 6-8. More specifically, the end 98 of the jig is inserted into the head 90 of a plastic lure 92 or live bait. The lure 92 is then caused to slide toward the eyelet 94. The tail 96 of the lure 92 is then near the barbed end 98 of the jig. The lure 92 is then twisted so that it faces toward the barbed end 98. The barbed end 98 then fits underneath the lure 92 and the tail 96 of the lure 92 may be attached and buried just below the surface of the lure 92. This is depicted in FIGS. 6, 7 and 8.

While there has been set forth a preferred embodiment of the invention, it is understood that the invention is to be limited only by the following claims and equivalents thereof.

What is claimed is:

1. A jig for fishing comprising:
a hook including a barbed and an eyelet end, said hook formed with a first generally flat planar curved section extending from the barbed end in the range of about 150° to 190°;
a first straight run section extending from the curved section coplanar with the curved section and barbed end;
a second straight, coplanar run section;
said first straight run section joined to the second generally coplanar straight run section and forming an obtuse angle therewith in the range of about 120° to 150°, said eyelet end comprising a generally coplanar eyelet connected to the second straight run section; and
a non-spherical, bulbous element formed generally symmetrically around the second straight run section.

2. The jig of claim 1 in combination with a generally straight rod element extending from the second straight section toward the barbed end.

3. The jig of claim 2 wherein the rod element is coplanar with the first and second sections and extends over the barbed end.

4. The jig of claim 1 wherein the bulbous element has a longitudinal dimension greater than about 50% of the longitudinal dimension of the second section.

5. The jig of claim 4 wherein the bulbous element has a maximum diameter less than one half the longitudinal dimension thereof.

6. The jig of claim 1 in combination with bait.

7. A weedless jig for fishing comprising:
a hook including a barbed end, an eyelet end, said hook formed with a first generally flat planar curved section extending from the barbed end in the range of about 150° to 190°;
a first straight run section coplanar with the curved section and extending therefrom;
a second coplanar straight run section extending from a juncture with the first straight run section and forming an obtuse angle therewith in the range of about 120° to 150°, said eyelet coplanar therewith and at the end of said second straight run section adjacent the eyelet, said ball symmetrically mounted on the second section.

8. The jig of claim 7 further including a generally straight rod extending from the junction toward the barbed end.
